(19) United States
(12) Patent Application Publication
(10) Pub. No.: US 2011/0026125 A1
(43) Pub. Date: Feb. 3, 2011

(54) Transparent conductive film structure and display device

(76) Inventors: Cheng-Chieh Chang, Taipei City (TW); Hsiu-Feng Liu, Jhongli City (TW); Pi-Jui Kuo, Jhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,973

(22) Filed: Jul. 29, 2009

(51) Int. Cl. G02B 1/10

(52) U.S. Cl. 359/601

(57) ABSTRACT

A transparent conductive film structure includes, a substrate and a multi-layer film formed on the substrate. The multi-layer film includes a reflection-matching layer and a transparent conductive layer. The reflection matching layer is applied to reduce the reflection index difference of the etched portion and the non-etched portion. Therefore, the etched traces cannot be observed by the users so that the image quality of the transparent conductive film structure is improved.

### BACKGROUND OF THE INVENTION

1. Field of the Invention

The present invention relates to a transparent conductive film structure and a display device. In particular, the present invention relates to a transparent conductive film structure and a display device with improved quality of images.

2. Description of Related Art

As technology has been developing, the usage of electronic devices increases. Currently, the touch panel (touch-screen) is widely used in electronic products, which is used instead of the traditional keypad so that it is more convenient for directly controlling the devices.

The touch panels are classified into various types of touch panel technology, such as resistive touch panel, capacitive touch panel, infrared touch panel, and ultrasonic-wave touch panel. The resistive touch panel and capacitive touch panel are commonly applied in the application. Capacitive touch screens can support Multitouch technology for easily controlling the system, therefore, the capacitive touch panels are more and more applied in the products. However, the capacitive touch panel only responds to finger contact and will not work with a gloved pen unless the pen is conductive. On the other hand, when an object, such as a finger, or pen, presses down on a point on the resistive touch panel, it causes a change in the electrical current which is registered as a touch event and sent to the controller for processing. In other words, it is easier to control the electronic device by the resistive touch panel. Furthermore, the cost of the resistive touch panel is lower than that of the capacitive touch screens so that the resistive touch panels are applied and developed on the electronic products.

The touch panel is manufactured by coating the glass substrate with a thin, transparent metallic layer. When a user touches the surface, the system records the change in the electrical current to input signals or detect the touched point.

The thin, transparent metallic layer has a circuit thereon by lithography and etching processes so as to form the driving circuit. However, some traces will be formed after the etching process and there is a large difference in the spectrum because the difference of the reflection indexes of the glass substrate and the layer. Therefore, image or shadow is resulted from and causes the lower quality of the display device.

Therefore, in view of this, the inventor proposes the present invention to overcome the above problems based on his expert experience and deliberate research.

### SUMMARY OF THE INVENTION

One particular aspect of the present invention is to provide a transparent conductive film structure. The transparent conductive film structure has a reflection-matching layer between a substrate and an outer transparent conductive layer. The thickness and the reflection index of the reflection-matching layer can be adjusted to reduce the reflection index difference of different portions (i.e., the etched portion and the non-etched portion). The reduction can eliminate the difference of images or of colors. Therefore, the etched traces cannot be observed by the users so that the image quality of the transparent conductive film structure is improved.

The transparent conductive film structure includes a substrate and a multi-layer film. The multi-layer film includes a reflection-matching layer and a transparent conductive layer. The reflection-matching layer is disposed on the substrate and the reflection-matching layer is a compound with a lower reflection index relative to the substrate. The transparent conductive layer is disposed on the reflection-matching layer. After being etched, the transparent conductive layer has an etched portion and a non-etched portion. The reflection-matching effect results in the reflection difference of the etched and the non-etched portion. Therefore, the etched portion and the non-etched portion have similar reflection indexes.

A display device with the transparent conductive film structure is further disclosed. The display device is provided for improving the image and the etched traces cannot be observed.

The thicknesses and the reflection indexes of the reflection-matching layer can be adjusted to produce a reflection matching effect. Therefore, the etched portion and the non-etched portion have similar reflection indexes for reducing the reflection index difference. Accordingly, the etched traces cannot be seen so as to improve the image quality.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 is a schematic diagram of a transparent conductive film structure of the present invention.

FIG. 2 is a schematic diagram showing the transparent conductive film structure after etching of the present invention.

### DETAILED DESCRIPTION OF THE PREFERRED EMBODIMENTS

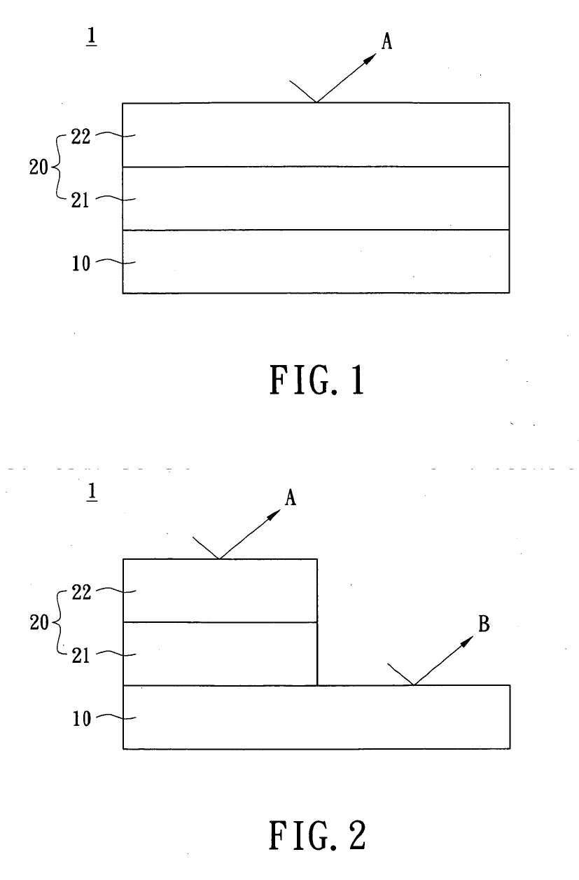

Reference is made to FIG. 1. The present invention provides a transparent conductive film structure 1. The surface reflection index of the transparent conductive film structure 1 can be adjusted so as to decrease the reflection index difference of the etched portion and the non-etched portion. Therefore, the traces by-produced in the etching process cannot be observed by human's eyes so that the transparent conductive film structure 1 of the present invention can provide improved image quality. The transparent conductive film structure 1 has a substrate 10 and a multi-layer film 20 stacked on the substrate 10. The multi-layer film 20 includes a reflection-matching layer 21 and a transparent conductive layer 22. The two layers are orderly stacked on the substrate 10. In other words, the reflection-matching layer 21 is more adjacent to the substrate 10 and the transparent conductive layer 22 is more far away from the substrate 10.

The arrangement of reflection indexes of the reflection-matching layer 21 and the transparent conductive layer 22 lead the reduction of the reflection index difference of two portions so that the traces formed in the etching process cannot be observed by human's eyes. The indexes and the thickness are shown below. The reflection-matching layer 21 is formed on the substrate 10 and the reflection-matching layer 21 is a compound with a lower reflection index relative to the substrate 10. The second reflection-matching layer 22 is formed on the first reflection-matching layer 21. The transparent conductive layer 22 is formed on the reflection-matching layer 21, and the transparent conductive layer 22 is an optical film with high conductivity and high refraction index.

Three embodiments are shown in Table. 1, but not restricted thereby.

| embodiment | layer | material | thickness (Å) |
|---|---|---|---|
| (1) | transparent | ITO | 180 |
| | conductive layer | | |
| | reflection- | SiO2 | 700 |
| | matching layer | | |
| (2) | transparent | ITO | 180 |
| | conductive layer | | |
| | reflection- | MgF2 | 800 |
| | matching layer | | |
| (3) | transparent | ITO | 180 |
| | conductive layer | | |
| | reflection- | MgF2 + SiO2 | 750 |
| | matching layer | | |

Reference is made to embodiment (1) of the present invention. The substrate 10 is made of glass and PET (polyethylene terephthalate) materials, but not restricted thereby. For example, the substrate 10 can be plastic board, such as PC (polycarbonate), PMMA (polymethyl methacrylate), PET (polyethylene terephthalate), ARTON, and so on. Alternatively, the substrate 10 can be a glass plate. Furthermore, the reflection index of the glass substrate 10 is about 1.52.

The reflection index of the reflection-matching layer 21 is about from 1.42 to 1.46. In other words, the reflection index of the reflection-matching layer 21 is lower than the reflection index of the substrate 10. Moreover, the reflection-matching layer 21 can be an oxide, a fluoride, or a mixture of oxide and fluoride. In the embodiment, the reflection-matching layer 21 is made of SiO2 material and the thickness of the reflection-matching layer 21 is about 700 angstrom.

The transparent conductive layer 22 can be made of SnO2, ZnO2, In2O3, or ITO materials, and the thickness of the transparent conductive layer 22 can be about form 130 to 200 angstrom. In embodiment (1), the transparent conductive layer 22 is made of ITO material and the thickness of the transparent conductive layer 22 is about 180 angstrom. The transparent conductive layer 22 is a surface layer and the high refraction index of the surface layer is between 1.9 and 2.1. Moreover, the transparent conductive layer 22 preferably has high conductivity so that the grounding process can be improved and the manufacturing yield can be increased. Because of the conductivity of the transparent conductive layer 22, the electrode can be formed efficiently on the transparent conductive layer 22. Therefore, the present invention can be applied for the application of the touch panel.

Please refer to Table. 1; the difference between embodiment (1) and (2) is that the reflection-matching layer 21 of embodiment (2) is made of a fluoride material, for example an MgF2 material, and the thickness of the reflection-matching layer 21 of embodiment (2) is about 800 angstrom.

On the other hand, the difference between embodiment (1) and (3) is that the reflection-matching layer 21 of embodiment (2) is made of a mixture of oxide and fluoride materials, for example a mixed film of SiO2 and MgF2 materials. The thickness of the mixed reflection-matching layer 21 of embodiment (3) is about 750 angstrom.

According to the embodiments of Table. 1, the transparent conductive film structure 1 has the following structures. The substrate 10 is made of glass and PET materials. The reflection-matching layer 21 has a lower reflection index relative to the substrate 10. The reflection index of the reflection-matching layer 21 is about from 1.42 to 1.46, and the thickness of the reflection-matching layer 21 is of from 300 to 800 angstrom. For example, the reflection-matching layer 21 is made of an oxide, such as SiO2 material with thickness of 700 angstrom. Alternatively, the reflection-matching layer 21 is made of a fluoride material, such as MgF2 material with thickness of 800 angstrom. Further alternatively, the reflection-matching layer 21 is made of a mixture of oxide and fluoride materials, such as mixed layer of SiO2 and MgF2 with thickness of 750 angstrom. The thickness of the transparent conductive layer 22 is of from 130 to 200 angstrom. The transparent conductive layer 22 is made of ITO material.

Please refer to FIG. 1; the transparent conductive film structure 1 has reflection index A (the arrow shown in FIG. 1), before being etched. On the other hand, the transparent conductive film structure 1 is formed as a step structure after being etched. As shown in FIG. 2, the transparent conductive film structure 1 has an etched portion (lower portion) and a non-etched portion (higher portion). The etched portion and the non-etched portion of the transparent conductive film structure 1 respectively have a first reflection index (arrow B) and a second reflection index (arrow A). Depending on the thickness and the reflection index of the reflection-matching layer 21, the first reflection index is approximate to the second reflection index. Therefore, the formed traces in the etching process cannot be observed by human's eyes because the two portions of the transparent conductive film structure 1 have approximate reflection indexes. Thus, the displayed images of the two portions are adjusted approximate to each other so that the formed traces in the etching process cannot be observed by human's eyes. Furthermore, the quality of the transparent conductive film structure 1 is improved.

In the above-mentioned embodiment, the first reflection index of the etched portion is 8.6, and the second reflection index of the non-etched portion is 8.8. Therefore, the images or lights displayed on the two portions are similar with or identical to each other so that the stepped structure formed in etching processes cannot be observed by human.

Moreover, the transparent conductive film structure 1 can be used in display units, such as LCD, CRT, touch panel and other devices having such display units.

The present invention has the following characteristics.

1. The reflection matching layer is applied to reduce the reflection difference of the etched and the non-etched portion. Therefore, the two portions can display the similar image, and the etched traces cannot be observed by the users so that the image quality of the transparent conductive film structure is improved.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A transparent conductive film structure, comprising: a substrate and a multi-layer film, the multi-layer film including a reflection-matching layer and a transparent conductive layer, wherein,
the reflection-matching layer is disposed on the substrate, and the reflection-matching layer is a compound with a lower reflection index relative to the substrate;
the transparent conductive layer is disposed on the reflection-matching layer, the transparent conductive layer has an etched portion with a first reflection index and a non-etched portion with a second reflection index, and the first reflection index is approximate to the second reflection index.

2. The transparent conductive film structure as claimed in claim 1, wherein the substrate is made of glass material, PET material, or a mixture of glass and PET materials.

3. The transparent conductive film structure as claimed in claim 2, wherein the substrate of glass has a reflection index of 1.52.

4. The transparent conductive film structure as claimed in claim 3, wherein the reflection-matching layer has a reflection index of from 1.42 to 1.46.

5. The transparent conductive film structure as claimed in claim 4, wherein the reflection-matching layer has a thickness of from 300 to 800 angstrom.

6. The transparent conductive film structure as claimed in claim 5, wherein the reflection-matching layer is made of an oxide material, a fluoride material, or a mixture of oxide and fluoride materials.

7. The transparent conductive film structure as claimed in claim 6, wherein the reflection-matching layer is made of SiO2 material.

8. The transparent conductive film structure as claimed in claim 6, wherein the reflection-matching layer is made of MgF2 material.

9. The transparent conductive film structure as claimed in claim 6, wherein the reflection-matching layer is made of SiO2 and MgF2 materials.

10. The transparent conductive film structure as claimed in claim 6, wherein the transparent conductive layer is made of ITO material, and the transparent conductive layer has a thickness of from 130 to 200 angstrom.

11. The transparent conductive film structure as claimed in claim 10, wherein the first reflection index of the etched portion is 8.6, and the second reflection index of the non-etched portion is 8.8.

12. A display device having the transparent conductive film structure as claimed in claim 1.
